(19) United States
(12) Patent Application Publication
(10) Pub. No.: US 2015/0323253 A1
(43) Pub. Date: Nov. 12, 2015

(54) Fresh Hamper System

(71) Applicant: Alkhalique Hamilton, Grayson, GA (US)

(72) Inventor: Alkhalique Hamilton, Grayson, GA (US)

(21) Appl. No.: 14/271,314

(22) Filed: May 6, 2014

(51) Int. Cl. F26B 9/06

(52) U.S. Cl. CPC F26B 9/06

(57) ABSTRACT

A fresh hamper system includes an enclosure, with meshed opening for airflow distribution. The invention minimizes unpleasant odors and mildew in moist or warn clothing, linen, shoes or fabrics. At least one fan attached to a structure distributes air mixed with a user defined liquid solution pumped using at least one spray pump connecting to at least one reservoir. The system can be portable and placed in any room or space. A series of garment hangers are mounted in the portable system for hanging items to be stored for some period of time prior to cleaning. An alternative method includes installing the fresh hamper system in a room or gym locker environment to treat larger spaces. The fresh hamper system further includes a catch basin with drain tubing to drain the system.

### FIELD OF THE INVENTION

This invention relates generally to storing clothes, fabric, linen, and shoes in an environment that will minimize un-pleasant odors and the formation of mildew.

### BACKGROUND OF THE INVENTION

It is very common for gym clothes and other fabrics exposed to wet conditions to absorb moisture which can lead to unpleasant odors and possibly mold or mildew if not treated immediately. Some studies suggest pre-treating fabrics with certain chemicals, for instance, febreze, dis-infecting solution, baking soda, lemon juice acids, vinegar, laundry detergents, ammonia etc., to minimize odors in work out clothing. Other studies discourage placing worn gym clothing in bags or at the bottom of piles in hampers, where moisture and odors cannot escape the fabrics. Odors and stains are difficult to remove from fabric after sitting for some time. People are forced to replace these clothes often or wash them frequently. There are times when it is necessary to store “dirty” clothing for extended periods of time prior to washing. Often, a laundry bag or standard hamper of sort is used. “Dirty” clothes that sit in these environments for extended periods are subject to mold formation as well as absorbing odors that are difficult to rid. A machine or system used to minimize unpleasant odors and mildew in clothing, shoes and other fabrics that have been exposed to moist and unpleasant odor conditions, ie., workout clothes, soiled linen, gym shoes, etc. would prove effective at maintaining fresher clothing, while promoting more sanitary environments.

An article in Mens Fitness magazine by Natasha Samuel details methods to “Get the smell of rotting death out of your gym clothes.” REFERENCE: http://www.mensfitness.com/styleandgrooming/fashion/get-the-smell-of-rotting-death-out-of-your-gym-clothes. An article on Shape.com by Alanna Nunez explains “4 Ways to Keep Your Gym Clothes Clean and Fresh.” REFERENCE: http://www.shape.com/blogs/shape-your-life/4-ways-keep-your-gym-clothes-clean-and-fresh. On healthyliving.com, Kimberly Caines discusses “How to Keep Work Out Clothes From Stinking.” REFERENCE: http://healthyliving.azcentral.com/keep-work-out-clothes-stinkin-6796.html. A blog forum on LetsRun.com debates methods to keep gym shorts smelling fresh without daily laundering. REFERENCE: http://www.letsrun.com/forum/flat_read.php?thread=3727899. An article on Jezebel.com by Jolie Kerr explains “What To Do When Your Gym Clothes REEK.” REFERENCE: http://jezebel.com/what-to-do-when-your-gym-clothes-reek-1141402734.

Garment refreshing systems have been patented, however these systems generally are complicated and tend to be expensive. For example, the “clothes rejuvenator” described in U.S. Pat. No. 3,670,425 is a system including a blower-dryer and a vaporizer which are operable to admit steam and a heated current of air to a cabinet. A control enclosure is also provided in the cabinet including automatic controls for a heater and vaporizer. The steam created by the vaporizer is claimed to steam out creases as garments hang in the cabinet, while the heated current of air dries and sanitizes damp, limp and musty clothing.

U.S. Pat. No. 5,323,897 describes a portable enclosure for the placement of wet articles for storage and at least partial drying, including a rigid plastic frame including an article hanger enclosed by a housing with a top, bottom and sides. At least three of the sides and the top are at least partially formed of a mesh material and at least the bottom is impervious. An exteriorly extending adjustable length strap with Velcro type closure means attached to the frame can be looped over an external support to support the enclosure and contents. A container is located in the bottom of the housing to catch any liquid dripping from the wet articles to contain the dripping within the housing. A zippered opening in one wall is provided for selected entry into the interior of the housing.

A method for cleaning and refreshing fabrics is detailed in U.S. Pat. No. 6,893,469 B1. The following steps are proposed: placing the fabric article in a container having an opening and at least one wall that defines an interior void space. Then the temperature and relative humidity of the air within the interior void space of the container are raised to a predetermined first temperature and a predetermined first relative humidity for a predetermined first period of time. Finally, at least one of the temperature or the relative humidity of the air within the interior of void space of the container are changed at the end of the first period of time to a predetermined second temperature and a predetermined second relative humidity for a predetermined second period of time. Ultimately temperature and relative humidity control is used to treat the fabrics.

In 2005, Maytag Corporation was assigned U.S. Pat. No. 6,910,292 B2 which details a clothes drying cabinet provided with an internal compartment for receiving clothes and having a plurality of air inlet nozzles. Including an air plenum that provides air to the cabinet through the nozzles. The plenum has a decreasing cross section from one corner to an opposite corner to provide a balanced distribution of air through the nozzles at a substantially uniform velocity. The nozzles are oriented angularly to direct air across upper and lower surfaces of shelves mounted within the drying compartment.

U.S. Pat. Application Publication No. 2005/0120757 A1 discloses a garment refreshing system including an enclosure having a top, a bottom, a sidewall, an air inlet and an air outlet, and a hook or other element on the top to facilitate hanging in a convenient location. An electrical fan at the air inlet is operative to bring air into the enclosure and past the clothing to the air outlet, and a filter supported at the air outlet for collecting odors removed from the clothing. It is also suggested that the use of a low-voltage D.C. fan facilitates use in a vehicle. The application further describes the use of an absorbent material placed at the air inlet to receive a deodorizer or fragrance.

Japanese Abstract No. 03097186 was published and pertains to a clothes refreshing device that circulates hot and humid air produced by a steam generating means inside a housing in which clothing has been placed, moisture and heat is given to the clothes so that the recovery of fibers is promoted and the wrinkles in the clothes are removed. Additionally, the clothes can be deodorized by the circulating hot and humid air. The moisture in the components of odor that are dissolved is drained outside the device as water.

With regards to products that are commercially available, a plethora of clothes and closet purifiers are readily available that are portable units that hang in closets or garment bags, and silently “neutralizes” odors and airborne pollutants using ion separating techniques. This technology utilizes super oxygenated molecules to oxidize and neutralize pollutants, plus negative ions to pull them out of the air. California Closets and Whirlpool has a joint venture to produce “The Personal Valet,” which is supposed to use a heated mist to remove wrinkles and odors from clothes hanging in a closet.

### SUMMARY OF THE INVENTION

This invention improves upon the existing art by providing a cost effective system to minimize unpleasant odors as well as formation of mildew to promote cleaner clothing and more sanitary environments. In terms of apparatus, the system includes a support structure to hold at least one fan motor coupled to a fan, at least one reservoir, at least one spray pump including supply tubing connecting the reservoir and spray pump, and a sloped catch basin including a drain tube connected to the catch basin. A portable embodiment of the Fresh Hamper system is dimensioned similarly to a standard laundry hamper basket for placement in a bedroom, bathroom, closet or laundry room. The portable system further includes garment hangers for holding warn articles of clothing or similar fabrics, linen or shoes. A meshed enclosure on at least four walls connects to a rectangular base for upright orientation and protects the contents of the system as well as users from the fan and electronics.

In the portable embodiment, garments are placed on the garment hangers. A user defined LIQUID solution maintained at ambient room temperature is put into the reservoir. The user of the Fresh Hamper system can add contents (liquid solution only) to the reservoir that will provide disinfecting, deodorizing and other fabric conditioning solutions to the supply pump(s). The Fresh Hamper system makes no claims stating the requirements of the contents in the reservoir other than the contents shall be of liquid solution between 60 and 80° F. Users of the Fresh Hamper system take full responsibility for the contents and mixtures placed in the reservoir. A control circuit operates the motor/fan(s) and spray pump(s). Electrical wiring is terminated in a centralized location and protected from foreign matter and moisture.

An alternate implementation of the Fresh Hamper system can be installed in a locker room on connected sections of lockers. A mesh screen protects the system components as well as people from the equipment. A sloped catch basin with drain tubing collects moisture and sprayed solution for easy draining. Control circuits control the operation of the fans and spray pumps. Locker rooms implementing the Fresh Hamper system will be inherently more sanitary.

A separate alternate implementation of the Fresh Hamper system can be installed in a laundry room on a wall section. A mesh screen protects the system components as well as people and animals from the equipment. A sloped catch basin with drain tubing collects moisture and sprayed solution for easy draining. Control circuits control the operation of the fans and spray pumps. Laundry rooms implementing the Fresh Hamper system will inherently be more sanitary.

### BRIEF DESCRIPTION OF THE DRAWINGS

FIG. 1.A is an isometric view of a preferred embodiment with portable system according to the invention;

FIG. 1.B is a side view of the embodiment of FIG. 1.A;

FIG. 1.C is a front view of the embodiment of FIG. 1.A;

FIG. 1.D is a top view of the embodiment of FIG. 1.A;

FIG. 2.A is a front view of an alternative embodiment installed in a Locker Room according to the invention;

FIG. 2.B is an isometric view of the embodiment of FIG. 2.A;

FIG. 3.A is an isometric view of an alternative embodiment installed in a Laundry Room according to the invention;

FIG. 3.B is a front view of the embodiment of FIG. 3.A;

FIG. 3.C is an isometric view of the embodiment of FIG. 3.A (with no room walls shown for clarity); and

FIG. 3.D is a front view of the embodiment of FIG. 3.A (with no room walls shown for clarity);

### DETAILED DESCRIPTION OF THE INVENTION

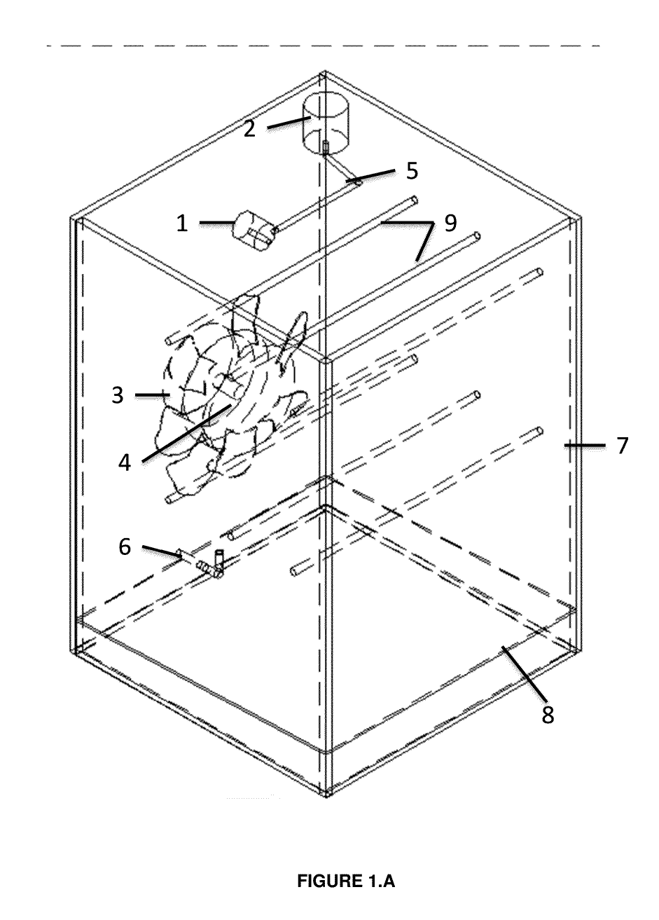

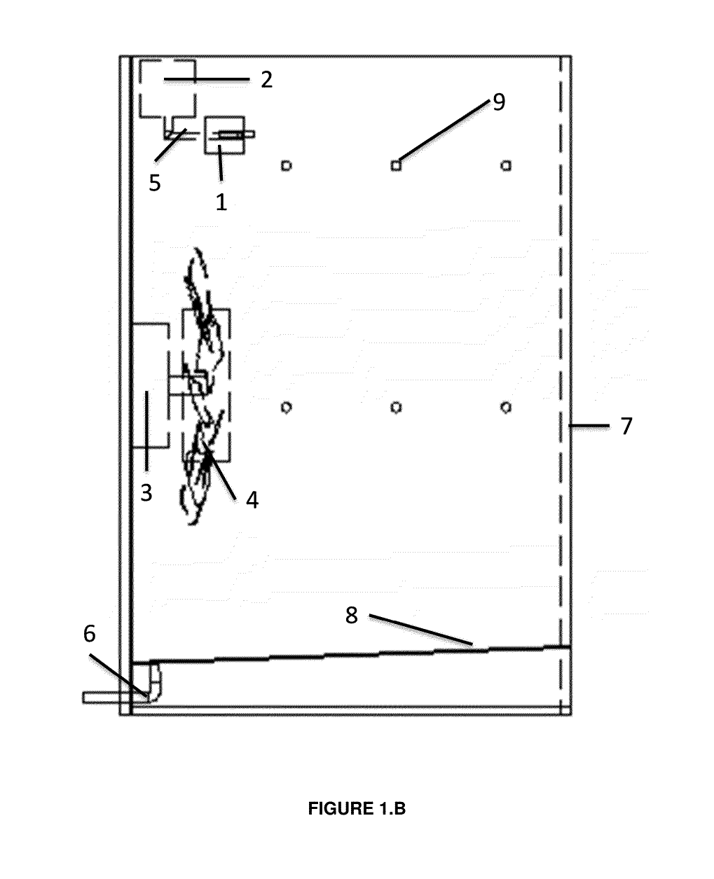

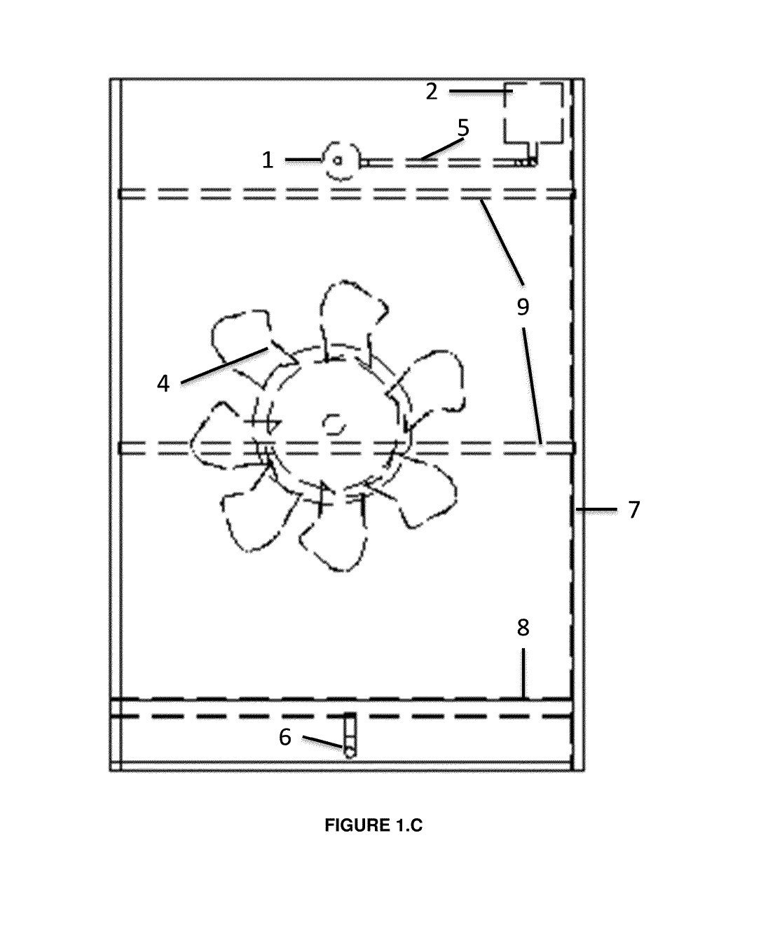

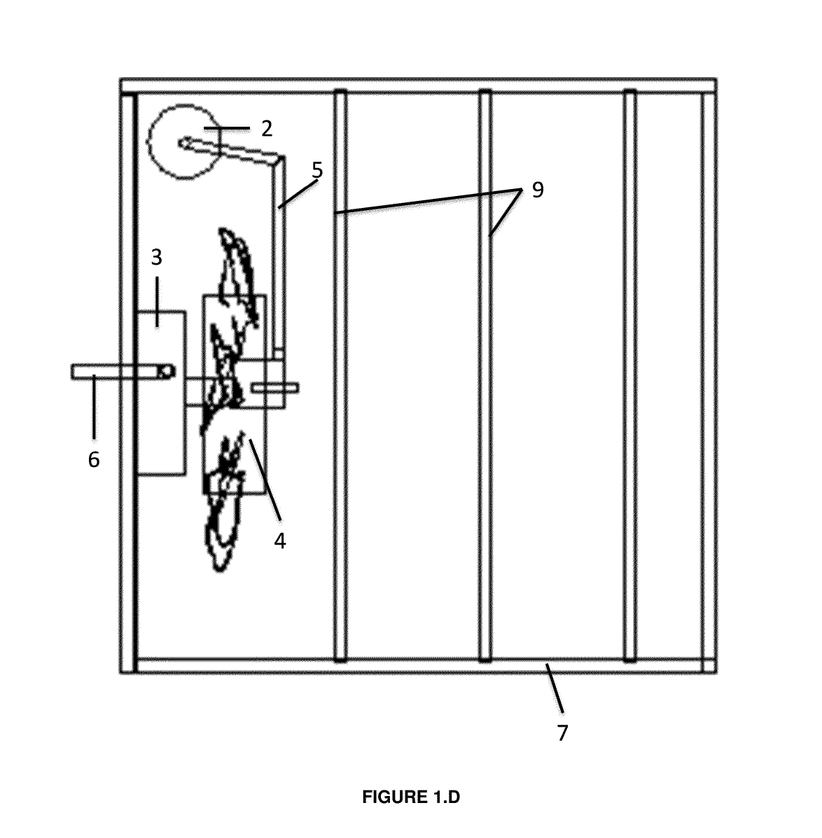

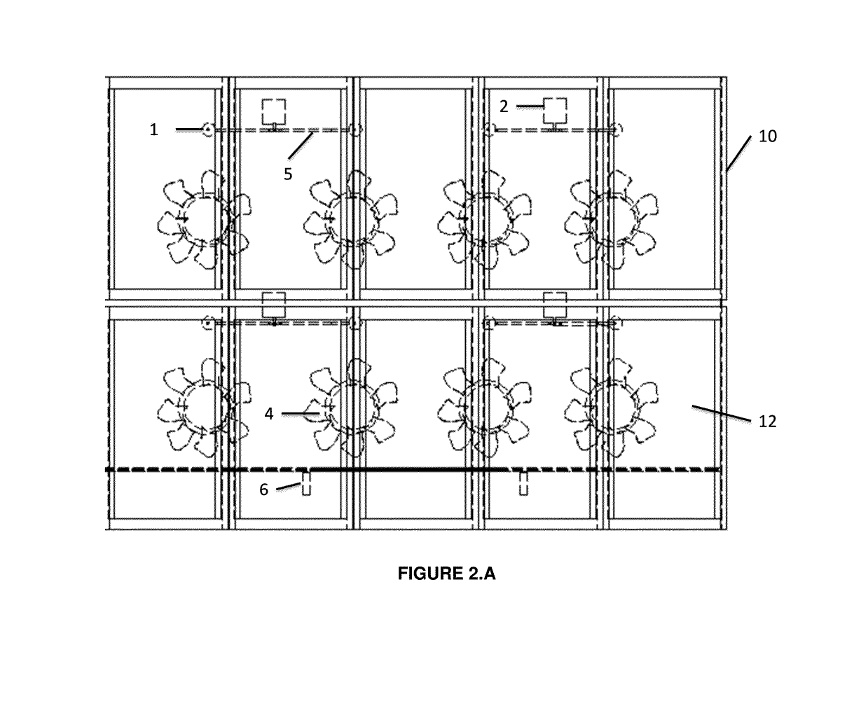

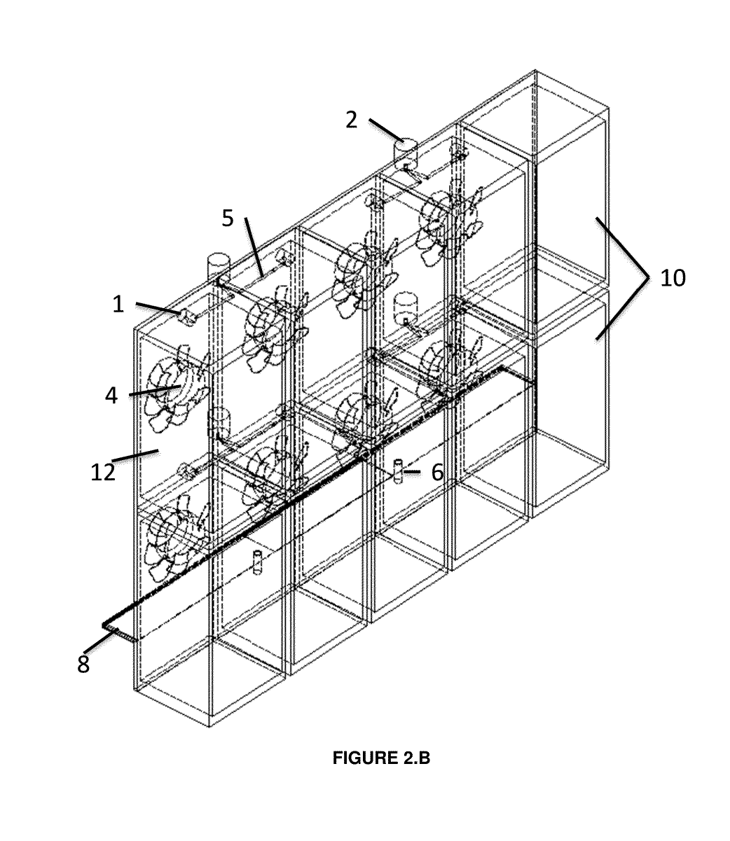

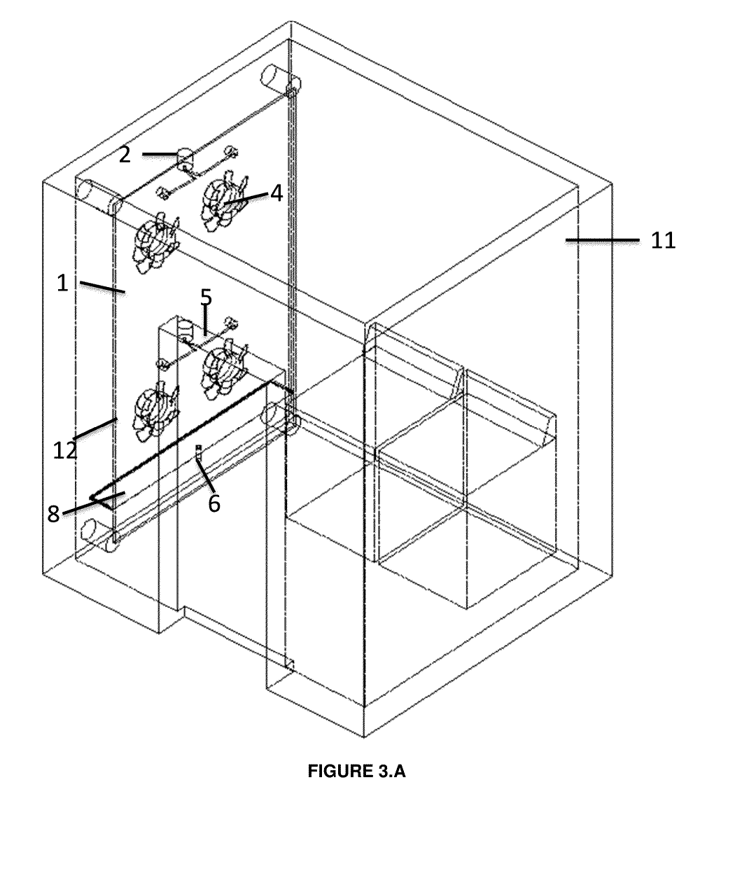

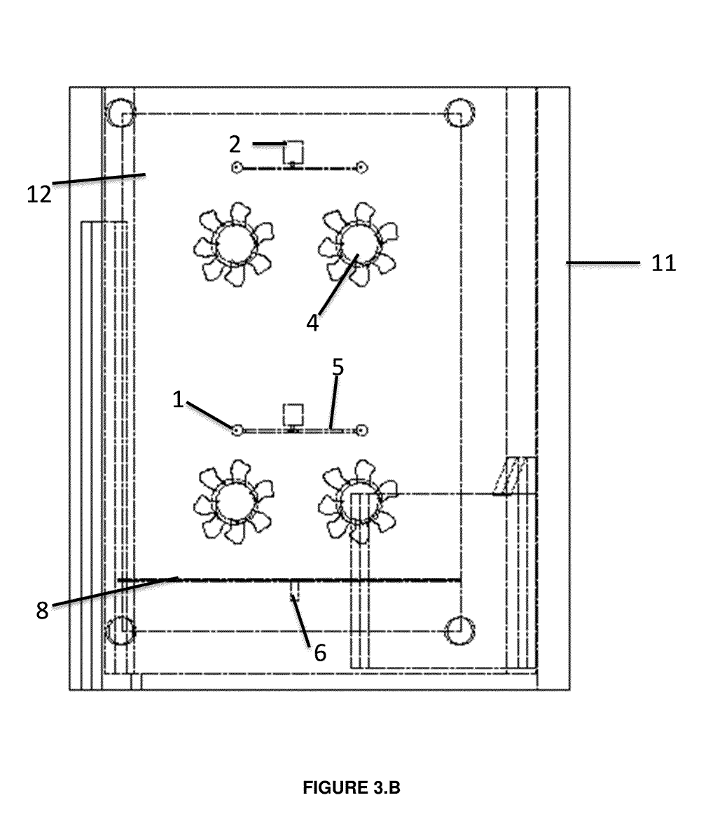

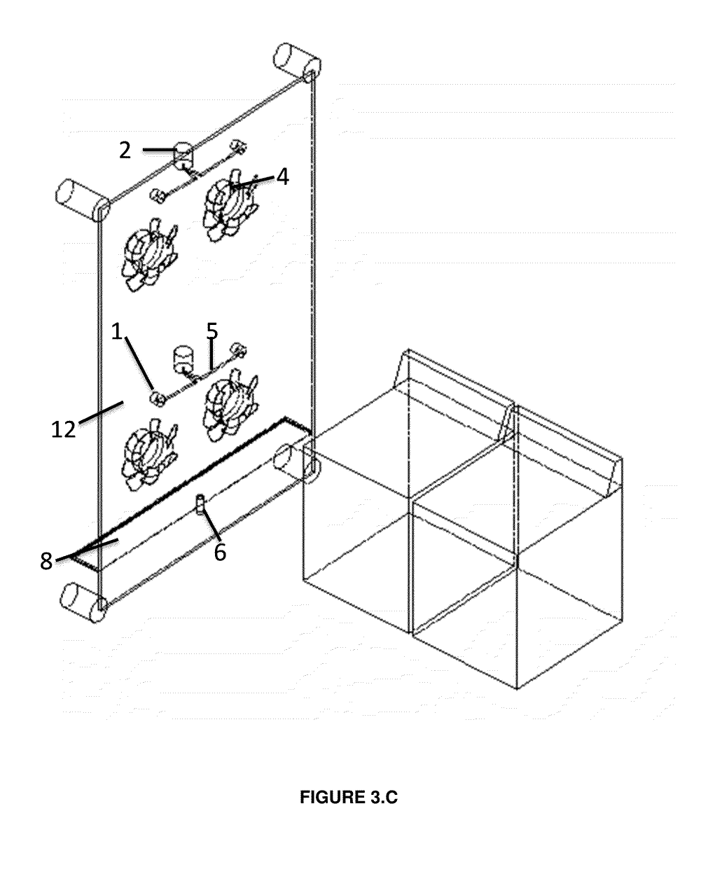

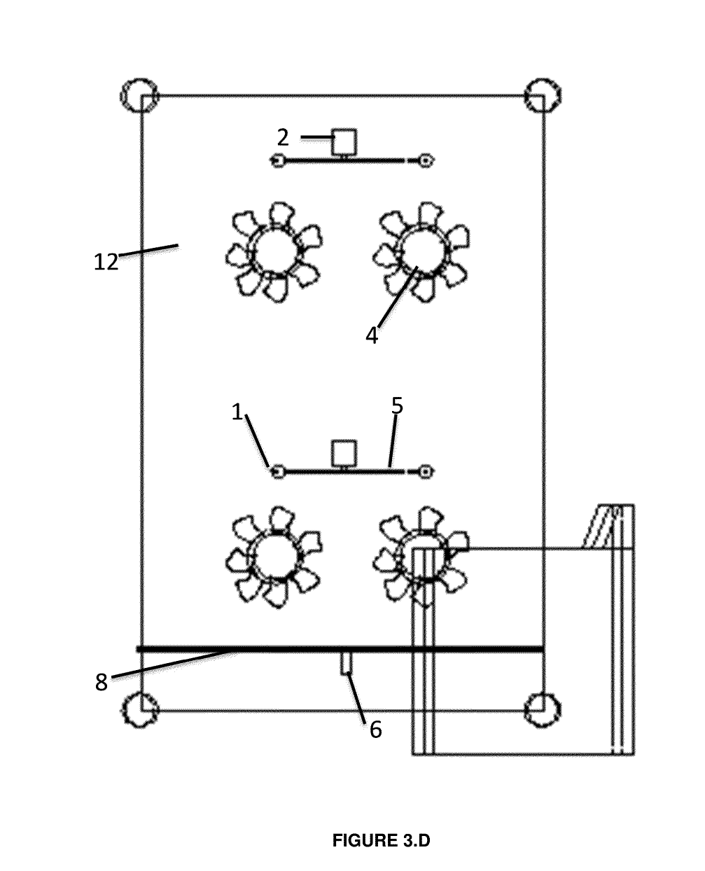

Now looking at the drawings, FIG. 1.A is an isometric view of a preferred embodiment of the invention. The Fresh Hamper system includes a fan motor 3 controlled by a simple control circuit turning on/off at the user's discretion to drive a fan 4. The fan 4 has a spray pump 1 with inlet nozzle connected to a reservoir 2 and outlet nozzle positioned above the fan 4 to spray a user defined liquid solution into the forced air. Supply tubing 5 connects the reservoir 2 with the spray pump 1. With the preferred embodiment of FIG. 1.A, a mesh screen enclosure 7 protects the fan 4, spray pump 1 and reservoir 2. With the alternate embodiments of FIG. 2.A and FIG. 3.A, a meshed protective covering 12 protects the fans 4, spray pumps 1 and reservoirs 2. The embodiment of FIG. 2.A would supply locker sections 10 within a locker room. The embodiment of FIG. 3.A would supply a laundry room 11.

The spray pump(s) 1 are controlled to spray at pre-defined intervals while the fan(s) 4 are running. The Fresh Hamper system does not specify any exact formula that can be used in the reservoir. The only requirements specified with the Fresh Hamper system are that the solution be of liquid form at temperatures ranging between 60 and 80° F. The user has all freedom and thus accepts all responsibility for the chemicals that are used in the Fresh Hamper system. The reservoir(s) and spray pump(s) are designed to accept a liquid solution between 60 and 80° F. and will maintain ambient room temperature.

The forced air mixed with the solution flows over the contents within the Fresh Hamper system. Garments, gym shoes, linen, clothing, ect is placed in the path of the conditioned air. These contents are allowed to air dry in this space and are also conditioned by the solution that is spray mixed with the air. The solution can be dis-infecting spray, scented fragrance, ect. The Portable Fresh Hamper system has a series of garment hangers 9 for hanging the contents within the system. The Fresh Hamper system can also be installed in a series of lockers 10 or in a laundry room 11. Moisture from the soaked garments, as well as solution sprayed into the air, drops to the catch basin 8. The catch basin is sloped for draining and can be easily removed for cleaning. A capped drain tubing 6 is connected at the low point of the catch basin for draining the Fresh Hamper system. The fan motor, fan, spray pump, reservoir and connecting tubing are held in place by a mechanical support structure attached to the frame of the Fresh Hamper system.

I claim:

1. Fresh hamper system apparatus, comprising;
an enclosure having a bottom, four side walls, the enclosure being dimensioned to receive one or more articles of clothing, fabric, linen, and/or shoes;
a fan near one of the side walls forcing air across the enclosure;
an electric motor driving the fan;
a reservoir comprising a user defined solution to mix with the forced air moving across the enclosure;
a supply tubing connecting at one end to the reservoir;
a spray pump attached to the other end of the supply tubing and positioned above the fan;
a catch basin sloped to one end and positioned near the bottom of the enclosure; and
a drain tubing connecting to the catch basin with a removable cap for draining the apparatus.

2. The fresh hamper apparatus of claim 1, further including garment hangers supported by two opposing side walls within the enclosure to receive clothing, shoes, fabric, and linens.

3. The fresh hamper apparatus of claim 1, wherein the fan motor, fan, reservoir, supply tubing and spray pump are attached to support bracing at one of the side walls.

4. The fresh hamper apparatus of claim 1, wherein the catch basin is easily accessible for removal and cleaning.

5. The fresh hamper apparatus of claim 1, wherein a control circuit to control the fan motor and spray pump is protected in a water proof casing; and stored in a position not interfering with the garment hangers, fan, fan motor, spray pump or reservoir.

6. The fresh hamper apparatus of claim 1, wherein the four side walls of the enclosure have meshed openings to promote free air flow in and out of the enclosure.

7. The fresh hamper apparatus of claim 1, wherein the apparatus is sized similarly to a standard hamper.

8. Fresh hamper system apparatus, comprising;
a fan forcing air through a protective covering;
an electric motor driving the fan;
a reservoir comprising a user defined solution to mix with the forced air moving through the protective covering;
a supply tubing connecting at one end to the reservoir;
a spray pump attached to the other end of the supply tubing and positioned above the fan;
a catch basin sloped to one end and positioned near the bottom of the apparatus; and
a drain tubing connecting to the catch basin with a removable cap for draining the apparatus.

9. The fresh hamper apparatus of claim 8, wherein the fan motor, fan, reservoir, supply tubing and spray pump are attached to a support bracing network.

10. The fresh hamper apparatus of claim 8, wherein a control circuit to control the fan motor and spray pump is protected in a water proof casing; and stored in a position not interfering with the, fan, fan motor, spray pump or reservoir.

11. The fresh hamper apparatus of claim 8, wherein the protective covering is made of a meshed material to promote free air flow.

12. The fresh hamper apparatus of claim 8, wherein the apparatus is implemented into a large space, for example a section of lockers in a gym room.

13. Fresh hamper system apparatus, comprising;
a fan forcing air through a protective covering;
an electric motor driving the fan;
a reservoir comprising a user defined solution to mix with the forced air moving through the protective covering;
a supply tubing connecting at one end to the reservoir;
a spray pump attached to the other end of the supply tubing and positioned above the fan;
a catch basin sloped to one end and positioned near the bottom of the apparatus; and
a drain tubing connecting to the catch basin with a removable cap for draining the apparatus.

14. The fresh hamper apparatus of claim 13, wherein the fan motor, fan, reservoir, supply tubing and spray pump are attached to a support bracing network.

15. The fresh hamper apparatus of claim 13, wherein a control circuit to control the fan motor and spray pump is protected in a water proof casing; and stored in a position not interfering with the, fan, fan motor, spray pump or reservoir.

16. The fresh hamper apparatus of claim 13, wherein the protective covering is made of a meshed material to promote free air flow.

17. The fresh hamper apparatus of claim 13, wherein the apparatus is implemented into a room, for example a laundry room, bed room or bath room; and connected to a wall in said room.

18. Fresh hamper system apparatus, comprising;
a fan forcing air through a protective covering;
an electric motor driving the fan;
a reservoir comprising a user defined solution to mix with the forced air moving through the protective covering;
a supply tubing connecting at one end to the reservoir;
a spray pump attached to the other end of the supply tubing and positioned above the fan;
a catch basin sloped to one end and positioned near the bottom of the apparatus; and
a drain tubing connecting to the catch basin with a removable cap for draining the apparatus.

19. The fresh hamper apparatus of claim 18, wherein the fan motor, fan, reservoir, supply tubing and spray pump are attached to a support bracing network.

20. The fresh hamper apparatus of claim 18, wherein a control circuit to control the fan motor and spray pump is protected in a water proof casing; and stored in a position not interfering with the, fan, fan motor, spray pump or reservoir.

21. The fresh hamper apparatus of claim 18, wherein the protective covering is made of a meshed material to promote free air flow.

22. The fresh hamper apparatus of claim 18, wherein the apparatus is implemented into an automobile space, for example a dash board, rear seat back space or trunk space.
